(19) United States
(12) Patent Application Publication
(10) Pub. No.: US 2025/0118091 A1
(43) Pub. Date: Apr. 10, 2025

(54) METHOD FOR TRAINING MAP UPDATE MODEL, METHOD FOR UPDATING LANE-LEVEL MAP AND METHOD FOR NAVIGATING

(71) Applicant: Baidu Online Network Technology (Beijing) Co., Ltd., Beijing (CN)

(72) Inventors: Deguo XIA, Beijing (CN); Xiyan LIU, Beijing (CN); Weiming ZHANG, Beijing (CN); Wei ZHANG, Beijing (CN); Chenting GONG, Beijing (CN); Xiao TAN, Beijing (CN); Jizhou HUANG, Beijing (CN)

(21) Appl. No.: 18/983,955

(22) Filed: Dec. 17, 2024

(30) Foreign Application Priority Data
Nov. 13, 2024 (CN) 202411620689.8

(51) Int. Cl. G06V 20/56; G01C 21/00; G06V 10/82

(52) U.S. Cl. CPC G06V 20/588; G01C 21/3815; G06V 10/82

(57) ABSTRACT

Disclosed are a method and apparatus for training a map update model. The method may include: inputting a historical lane element corresponding to a road top view sample into the prior encoding network to generate a prior encoding feature; inputting the prior encoding feature and the road top view sample into the update network to generate lane update information; constructing a loss function based on the lane update information and a target lane element corresponding to the road top view sample; and adjusting a parameter of the map update model based on the loss function.

### CROSS-REFERENCE TO RELATED APPLICATIONS

This patent application claims the priority to and benefits of Chinese Patent Application No. 202411620689.8, filed on Nov. 13, 2024 and entitled “Method for Training Map Update Model, Method for Updating Lane-level Map and Method for Navigating,” the disclosure of which is incorporated herein by reference in its entirety.

### TECHNICAL FIELD

The present disclosure relates to the field of artificial intelligence technology, in particular to the technical fields of map navigation, autonomous driving, intelligent transportation, etc., and more particularly, to a method for training a map update model, a method for updating a lane-level map, and a method for navigating.

### BACKGROUND

Highly fresh lane-level maps are an indispensable infrastructure and key enabling technology to ensure the safety of autonomous driving systems and the user experience.

### SUMMARY

Embodiments of the present disclosure provide a method for training a map update model, a method for updating a lane-level map, a method for navigating, apparatuses thereof, a device and a storage medium.

In a first aspect, an embodiment of the present disclosure provides a method for training a map update model, the method including: inputting a historical lane element corresponding to a road top view sample into a prior encoding network to generate a prior encoding feature; inputting the prior encoding feature and the road top view sample into the update network to generate lane update information; constructing a loss function based on the lane update information and a target lane element corresponding to the road top view sample; and adjusting a parameter of the map update model based on the loss function.

In a second aspect, an embodiment of the present disclosure provides a method for updating a lane-level map, the method including: acquiring a road top view and a historical lane element corresponding to the road top view; inputting the road top view and the historical lane element into a map update model to generate lane update information, where the map update model is a map update model obtained by using the method described in any one of the implementations in the first aspect; and updating the lane-level map based on the lane update information.

In a third aspect, an embodiment of the present disclosure provides a method for navigating, the method including: performing route navigation based on a target lane-level map, where, the target lane-level map is the updated lane-level map obtained by using the method described in any one of the implementations in the second aspect.

In a fourth aspect, an embodiment of the present disclosure provides an apparatus for training a map update model, the apparatus including a first generation module, a second generation module, a function construction module, and a parameter adjustment module. The first generation module is configured to input a historical lane element corresponding to a road top view sample into a prior encoding network to generate a prior encoding feature; the second generation module is configured to input the prior encoding feature and the road top view sample into the update network to generate lane update information; the function construction module is configured to construct a loss function based on the lane update information and a target lane element corresponding to the road top view sample; and the parameter adjustment module is configured to adjust a parameter of the map update model based on the loss function.

In a fifth aspect, an embodiment of the present disclosure provides an apparatus for updating a lane-level map, the apparatus including a data acquisition module, a lane update module, and a map update module. The data acquisition module is configured to acquire a road top view and a historical lane element corresponding to the road top view; the lane update module is configured to input the road top view and the historical lane element into a map update model to generate lane update information, where the map update model is a map update model obtained by using the apparatus described in any one of the implementations in the fourth aspect.

In a sixth aspect, an embodiment of the present disclosure provides an apparatus for navigating, the apparatus including: a map navigation module, and the map navigation module is configured to: perform route navigation based on a target lane-level map, the target lane-level map being the updated lane-level map obtained by using the apparatus described in any one of the implementations in the fifth aspect.

In a seventh aspect, an embodiment of the present disclosure provides an electronic device, including: one or more processor; and a memory storing one or more instructions thereon, where the instructions are executed by the at least one processor, to enable the at least one processor to perform the method according to any one of the implementations in the first aspect, the second aspect, or the third aspect.

In an eighth aspect, an embodiment of the present disclosure provides a non-transitory computer readable storage medium, storing a computer instruction thereon, where the computer instruction when executed by a processor, implements the method according to any one of the implementations in the first aspect, the second aspect, or the third aspect.

It should be understood that the content described in this section is not intended to identify key or important features of the embodiments the present disclosure, nor to limit the scope of the present disclosure. Other features of the present disclosure will be easily understood through the following description.

### BRIEF DESCRIPTION OF THE DRAWINGS

FIG. 1 is an exemplary system architecture diagram to which the present disclosure may be applied;

FIG. 2 is a flowchart of an embodiment of a method for training a map update model according to the present disclosure;

FIG. 3 is a flowchart of another embodiment of the method for training a map update model according to the present disclosure;

FIG. 4 is a flowchart of an embodiment of a method for updating a lane-level map according to the present disclosure;

FIG. 5 is a schematic diagram of an application scenario of the method for updating a lane-level map according to the present disclosure;

FIG. 6 is a schematic diagram of an embodiment of an apparatus for training a map update model according to the present disclosure;

FIG. 7 is a schematic diagram of an embodiment of an apparatus for updating a lane-level map according to the present disclosure; and

FIG. 8 is a schematic structural diagram of a computer system adapted for implementing an electronic device according to an embodiment of the present disclosure.

### DETAILED DESCRIPTION OF EMBODIMENTS

The exemplary embodiments of the present disclosure are described below with reference to the accompanying drawings, which include various details of the embodiments of the present disclosure to aid in understanding and should be considered as merely exemplary. Therefore, it should be recognized by those of ordinary skill in the art that various changes and modifications may be made to the described embodiments without departing from the scope and spirit of the present disclosure. Similarly, for clarity and conciseness, descriptions of well-known functions and structures are omitted in the following description.

It should be noted that the embodiments and features within the embodiments of this disclosure may be combined with each other on a non-conflict basis. The present disclosure will be described in detail below with reference to the drawings and in conjunction with the embodiments.

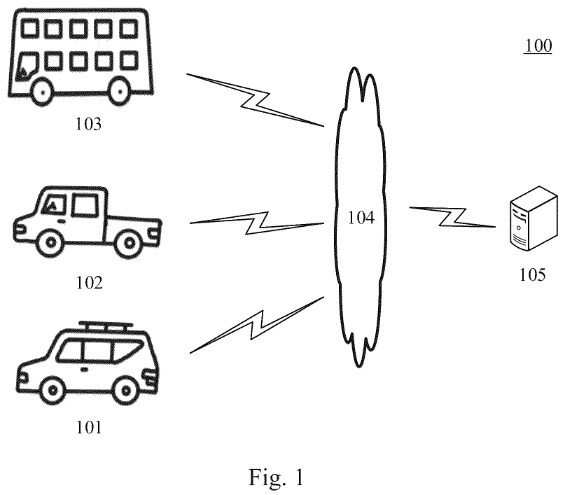

FIG. 1 shows an exemplary system architecture 100 to which

embodiments of a method for training a map update model of the present disclosure may be applied.

As shown in FIG. 1, the system architecture 100 may include terminal devices 101, 102, and 103, a network 104, and a server 105. The network 104 serves as a medium providing a communication link between the terminal devices 101, 102, and 103, and the server 105. The network 104 may include various types of connections, such as wired or wireless communication links, or optical cables.

Users may use the terminal devices 101, 102, and 103 to interact with the server 105 through the network 104 to receive or send messages and the like.

The terminal devices 101, 102, and 103 may be hardware or software. When the terminal devices 101, 102, and 103 are software, they may be installed in the electronic devices, and may be implemented as multiple pieces of software or software modules, or as a single piece of software or a single software module, which is not limited herein.

The server 105 may be a server providing various services, for example, inputting a historical lane element corresponding to a road top view sample into a prior encoding network to generate a prior encoding feature; inputting the prior encoding feature and the road top view sample into an update network to generate lane update information; constructing a loss function based on the lane update information and a target lane element corresponding to the road top view sample; and adjusting a parameter of the map update model based on the loss function.

It should be noted that the server 105 may be hardware or software. When the server 105 is hardware, it may be implemented as a distributed server cluster composed of multiple servers, or as a single server. When the server is software, it may be implemented as multiple pieces of software or software modules (such as used for providing a training service for a map update model), or as a single piece of software or a single software module, which is not limited herein.

It should be noted that the method for training a map update model provided in embodiments of the present disclosure may be performed by the server 105, or may be performed by the terminal devices 101, 102, and 103, or may be performed by the server 105 and the terminal devices 101, 102, and 103 in cooperation with each other. Accordingly, various parts (e.g., various units, sub-units, modules, sub-modules) included in an apparatus for training a map update model may all be provided in the server 105, or may all be provided in the terminal devices 101, 102, and 103, or may be provided in the server 105 and the terminal devices 101, 102, and 103, respectively.

It should be understood that the numbers of terminal devices, networks, and servers in FIG. 1 are only illustrative. According to implementation needs, there may be any number of terminal devices, networks, and servers.

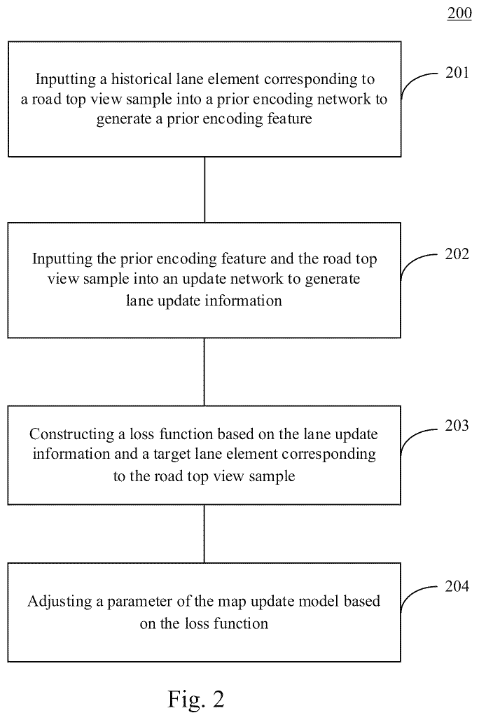

FIG. 2 shows a flow 200 of an embodiment of a method for training a map update model. The map update model may include a prior encoding network and an update network. The method for training a map update model may, in particular, include the following steps.

Step 201, inputting a historical lane element corresponding to a road top view sample into a prior encoding network to generate a prior encoding feature.

In the present embodiment, an executing body (e.g., the server 105 or the terminal devices 101, 102, and 103 in FIG. 1) may acquire a training sample set locally or at a remote server where the training sample set is stored.

The training sample set may include the road top view sample, and the historical lane element and a target lane element that correspond to the road top view sample, where the historical lane element is a lane element determined prior to generation of the road top view sample, and the target lane element is a lane element determined after the generation of the road top view sample.

Here, the lane element is used to indicate an element marked on the road that has a guiding function, such as a lane line, a lane marking, and the like, and the lane element may have different shapes and colours. The road top view sample may be obtained by collecting by using an image collection device mounted on a vehicle.

In particular, the vehicle may use vehicle-mounted sensing devices, such as vehicle-mounted radars, vehicle-mounted cameras, vehicle-mounted webcams or the like, to collect road data around the vehicle and perform coarse-grained change detection on the road data. If any change is detected, image collection is performed on the road section where the change occurs according to a preset collection strategy, to generate the road top view sample.

The collection strategy may be set based on the number of lanes, for example, if the number of lanes of the road section where the change occurs is less than or equal to a preset value, one-way image collection is performed on the road section; if the number of lanes of the road section where the change occurs is greater than the preset value, round-trip image collection is performed multiple times on the road section.

Here, the preset value may be 2, 3, etc., which is not limited herein.

The historical lane element corresponding to the road top view sample may be obtained by using the following method: mapping a region corresponding to the road top view sample to a historical lane-level map, to obtain a historical mapping region, and determining a lane element in the historical mapping region as the historical lane element.

The target lane element corresponding to the road top view sample may be obtained by using the following method: mapping the region corresponding to the road top view sample to a latest lane-level map, to obtain a latest mapping region, and determining a lane element in the latest mapping region as the target lane element.

Further, the executing body may input the historical lane element corresponding to the road top view sample into the prior encoding network to generate the prior encoding feature.

The prior encoding network may encode geometric features, semantic features and spatial relationship features of lane elements using a multi-head self-attention mechanism.

Here, the semantic features may include classes (e.g., structured road, unstructured road), instance numbers, etc. of the lane elements; the geometric features may include geometric shape data, poses, etc. of the lane elements; and the spatial relationship features may include topological spatial relationships, sequential spatial relationships, metric spatial relationships, etc. of the lane elements.

Step 202, inputting the prior encoding feature and the road top view sample into an update network to generate lane update information.

In the present embodiment, after obtaining the prior encoding feature, the executing body may input the prior encoding feature and the road top view sample into the update network to generate the lane update information.

The lane update information may include an updated lane element, i.e., a lane element after update, or may include both the updated lane element and a change type of the updated lane element, which is not limited herein.

Step 203, constructing a loss function based on the lane update information and a target lane element corresponding to the road top view sample.

In the present embodiment, the lane update information may be used as a predicted output of the map update model, the target lane element corresponding to the road top view sample may be used as a desired output of the map update model, and the lane update information may include the updated lane element. The executing body may construct the loss function using mean square error, or cosine similarity, etc., based on the updated lane element and the target lane element.

Step 204, adjusting a parameter of the map update model based on the loss function.

In the present embodiment, after obtaining the loss function, the executing body may adjust parameters of the prior encoding network and the update network included in the map update model based on the loss function, to obtain the map update model after the parameter adjustment.

Embodiments of the present disclosure provide the method for training a map update model, by inputting the historical lane element corresponding to the road top view sample into the prior encoding network to generate the prior encoding feature; inputting the prior encoding feature and the road top view sample into the update network to generate the lane update information; constructing the loss function based on the lane update information and the target lane element corresponding to the road top view sample; and adjusting the parameter of the map update model based on the loss function, i.e., by using the prior encoding feature containing the geometric feature, the semantic feature and the spatial relationship feature of the lane element as a reference to generate the lane update information, the accuracy of the generated lane update information is improved, thereby improving the accuracy of the map update model obtained by training.

In some alternative implementations, both the historical lane element and the target lane element may include an element vectorization point set and element style information.

In this implementation, the training sample set may include the road top view sample, and the historical lane element and the target lane element that correspond to the road top view sample, where, both the historical lane element and the target lane element may include the element vectorization point set and the element style information.

Here, the element style information may include element shapes and element colours, the vectorization point set consists of vector graphic elements (e.g., points, lines, circles, etc.) obtained by transforming pixels that constitute the lane elements, and the vector graphic elements may include coordinate information and orientation information.

In particular, the road top view sample provides the latest observation of a current road scene within a corresponding region R. A lane element (i.e., historical lane element) of a historical lane-level map in the region R corresponding to the road top view sample consists of the element vectorization point set P_{ori_his}={Pᵢ}ᵢ₌₀^{N}^{_{ori_his}}⁻¹ and the element style information L_{ori_his}={Lᵢ}ᵢ₌₀^{N}^{_{ori_his}}⁻¹. A lane element (i.e., target lane element) of a latest lane-level map in the region R corresponding to the road top view sample consists of the element vectorization point set Pₒᵣᵢ={Pᵢ}ᵢ₌₀^{N}^{ₒᵣᵢ}⁻¹ and the element style information Lₒᵣᵢ={Lᵢ}ᵢ₌₀^{N}^{ₒᵣᵢ}⁻¹.

Here, N_{ori_his} represents the number of historical lane elements corresponding to a single road top view sample, Lᵢ∈ [symbol] ^{c} represents the style of a single historical lane element, Nₒᵣᵢ represents the number of target lane elements corresponding to a single road top view sample, and c is a total number of styles.

In this implementation, by setting the lane element to include the element vectorization point set and the element style information, taking full account of the information, such as coordinates, colours, shapes, and the like, included in the lane element, the accuracy of a predicted lane element is improved.

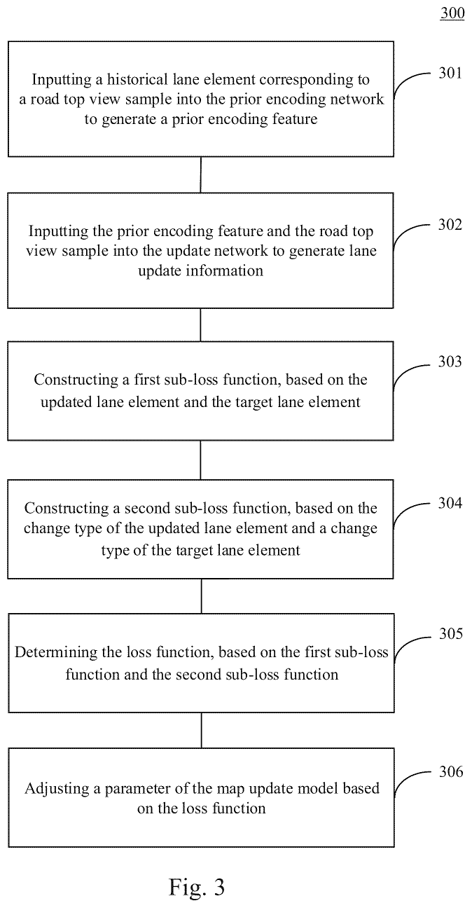

FIG. 3 shows a flow 300 of another embodiment of the method for training a map update model. The method for training a map update model may, in particular, include the following steps.

Step 301, inputting a historical lane element corresponding to a road top view sample into the prior encoding network to generate a prior encoding feature.

In the present embodiment, for the implementation details and technical effects of step 301, reference may be made to the description of step 201, and detailed description thereof will be omitted.

Step 302, inputting the prior encoding feature and the road top view sample into the update network to generate lane update information.

In the present embodiment, for the implementation details and technical effects of step 302, reference may be made to the description of step 202, and detailed description thereof will be omitted.

Step 303, constructing a first sub-loss function, based on the updated lane element and the target lane element.

In the present embodiment, the lane update information may include the updated lane element and a change type of the updated lane element. The executing body may construct the first sub-loss function using mean square error, or cosine similarity, etc., based on the updated lane element and the target lane element.

Step 304, constructing a second sub-loss function, based on the change type of the updated lane element and a change type of the target lane element.

In the present embodiment, the executing body may construct the second sub-loss function using mean square error, or cosine similarity, etc., based on the change type of the updated lane element and the change type of the target lane element.

Here, the change type of the target lane element may be obtained by matching the historical lane element with the target lane element.

In particular, a marking process of the change type of the target lane element L_{change}={CLᵢ}ᵢ₌₀^{N}^{ₒᵣᵢ}⁻¹, may include two phases: in a first phase, matching the Nori-1 historical lane element with the target lane element to obtain a preliminary change type of the target lane element; and in a second phase, determining the final change type of the target lane element through manual adjustment.

Here, Nₒᵣᵢ represents the number of lane elements in an image, and CLᵢ∈ [symbol] represents the change type of a single lane element.

Step 305, determining the loss function, based on the first sub-loss function and the second sub-loss function.

In the present embodiment, the executing body may determine the loss function directly based on the first sub-loss function and the second sub-loss function, or may determine the loss function based on the first sub-loss function, a first weight corresponding to the first sub-loss function, the second sub-loss function and a second weight corresponding to the second sub-loss function.

Here, the first weight corresponding to the first sub-loss function may be positively correlated with a preset first confidence threshold of the updated lane element, i.e., the higher the first confidence threshold, the greater the first weight; and the second weight corresponding to the second sub-loss function may be positively correlated with a preset second confidence threshold of the change type of the updated lane element, i.e., the higher the second confidence threshold, the greater the second weight.

In particular, the loss function L may be represented by the following formula:

$$L = α {L}_{l} + β {L}_{c}$$

where, Lₗ is the first sub-loss function, a is the first weight, L_{c} is the second sub-loss function, and β is the second weight.

Step 306, adjusting a parameter of the map update model based on the loss function.

In the present embodiment, for the implementation details and technical effects of step 306, reference may be made to the description of step 204, and detailed description thereof will be omitted.

In the above embodiment of the present disclosure, the first sub-loss function is constructed based on the updated lane element and the target lane element, the second sub-loss function is constructed based on the change type of the updated lane element and the change type of the target lane element, and the loss function is determined based on the first sub-loss function and the second sub-loss function. By further considering the change types of the lane elements, the map update model obtained by training may simultaneously generate the lane elements and the change types of the lane elements, thereby further improving the accuracy and reliability of the map update model obtained by training.

In some alternative implementations, the change type of the lane element may include: element style change, no change in element style, element addition, or element deletion.

In this implementation, the change type of the updated lane element or the change type of the target lane element may include element style change (e.g., a road indicator marking changing from yellow to white, a lane line changing from solid to dashed, etc.), no change in element style, element addition (e.g., adding a new lane line, adding a new road indicator marking, etc.), and element deletion (e.g., deleting an existing lane line, deleting an existing road indicator marking, etc.).

In particular, if CLᵢ∈ [symbol] ⁴ represents the change type of a single lane element, then 0 represents no change in element style, 1 represents element style change, 2 represents element addition, and 3 represents element deletion.

This implementation achieves the prediction to multiple change types by setting the change type to include: element style change, no change in element style, element addition, and element deletion.

In some alternative implementations, the inputting the prior encoding feature and the road top view sample into the update network to generate lane update information, includes: inputting the prior encoding feature and the road top view sample into a first update sub-network to generate the updated lane element; and inputting the updated lane element and the prior encoding feature into a second update sub-network to generate the change type of the updated lane element.

In this implementation, the update network may include the first update sub-network and the second update sub-network. After obtaining the prior encoding feature, the executing body may input the prior encoding feature and the road top view sample into the first update sub-network to generate the updated lane element, and input the updated lane element and the prior encoding feature into the second update sub-network to generate the change type of the updated lane element.

Here, the first update sub-network may include an encoding network, a fusion network and a decoding network. The executing body may first input the road top view sample into the encoding network to generate an image feature, then input the image feature and the prior encoding feature into the fusion network to generate a fusion feature, and input the fusion feature into the decoding network to generate the updated lane element.

The fusion network may fuse the image feature with the prior encoding feature using a cross-attention mechanism to obtain the fusion feature.

Here, the second update sub-network may be an association network for associating the updated lane element with the prior encoding feature to generate an association matrix, and an element in the association matrix is used to indicate the change type of the updated lane element.

In this implementation, by inputting the prior encoding feature and the road top view sample into the first update sub-network to generate the updated lane element, and inputting the updated lane element and the prior encoding feature into the second update sub-network to generate the change type of the updated lane element, the prior encoding feature is used to generate the updated lane element and the change type of the updated lane element respectively, which improves the accuracy and reliability of the generated updated lane element and the change type of the updated lane element.

In some alternative implementations, the inputting the updated lane element and the prior encoding feature into the second update sub-network to generate the change type of the updated lane element, includes: inputting the updated lane element and the prior encoding feature into a first association network to generate an initial association matrix; and inputting the initial association matrix into a second association network to generate a target association matrix.

In this implementation, the second update sub-network may include the first association network and the second association network. The executing body may first input the updated lane element and the prior encoding feature into the first association network to generate the initial association matrix, and then input the initial association matrix into the second association network to generate the target association matrix.

Here, the second association network may match the initial association matrix using a preset matching strategy to match each updated lane element with at most one historical lane element, and match each historical lane element with at most one target lane element, to obtain a matched association matrix. Further, the second association network may generate the target association matrix directly based on the matched association matrix.

One element in the target association matrix is used to indicate the change type of one lane element.

Here, a matrix element included in the target association matrix may be used to indicate the change type of the lane element. The change type may include element association, element addition, or element deletion, where element association refers to the presence of a historical lane element corresponding to the updated lane element among all the historical lane elements, and element association may further include two cases: element style change and no change in element style.

In particular, the change type of the lane element indicated by a matrix element in the target association matrix may include element association, element addition, or element deletion. The matrix element Mᵢⱼ in the target association matrix M is used to indicate an association relationship between the updated lane element i and the historical lane element j, i.e., whether there is the historical lane element j corresponding to the updated lane element i. If Mᵢⱼ=1, then the change type of the updated lane element i relative to the historical lane element j is element association, i.e., there is the historical lane element j corresponding to the updated lane element i. If Mᵢⱼ=0, then the updated lane element i and the historical lane element j are not associated, that is, there is no historical lane element j corresponding to the updated lane element i. In this case, it may be considered that the change type of the updated lane element i relative to the historical lane element j is element addition, and the change type of the historical lane element j relative to the updated lane element i is element deletion.

Further, based on the target association matrix M, the change type of the lane element may be classified into four classes. Class I: no change in element style, Mᵢⱼ=1, and the style of the updated lane element i is consistent with the style of the historical lane element j; Class II: element style change, Mᵢⱼ=1, and the style of the updated lane element i is inconsistent with the style of the historical lane element j; Class III: element addition, for the updated lane element i, Mᵢ=0, indicating that among all values of j, there is no historical lane element corresponding to the i-th updated lane element; and Class IV, element deletion, for the historical lane element j, Mⱼ=0, indicating that among all values of i, there is no updated lane element corresponding to the j-th historical lane element.

In this implementation, by inputting the updated lane element and the prior encoding feature into the first association network to generate the initial association matrix, and inputting the initial association matrix into the second association network to generate the target association matrix, the updated lane element and the prior encoding feature are first associated to the same feature space, and then matched to generate the target association matrix, which effectively improves the reliability of the generated target association matrix.

In some alternative implementations, the inputting the updated lane element and the prior encoding feature into a first association network to generate an initial association matrix, includes: inputting the updated lane element and the prior encoding feature respectively into a multilayer perceptron network to generate a first feature and a second feature; inputting the first feature and the second feature into an outer product network to generate a feature-level association matrix; and inputting the feature-level association matrix into a classification network to generate the initial association matrix.

In this implementation, the first association network may include the multilayer perceptron network, the outer product network and the classification network. The executing body may first respectively input the updated lane element and the prior encoding feature into the MLP (multilayer perceptron) network to generate the first feature and the second feature, then input the first feature and the second feature into the outer product network to generate the feature-level association matrix, and input the feature-level association matrix into the classification network to generate the initial association matrix.

The MLP network may unify the feature space of the updated lane element and the historical lane element, and the classification network may construct the initial association matrix at the confidence level.

Here, the outer product network is used to perform an outer product calculation on the first feature and the second feature to generate a feature-hierarchy association matrix, i.e., the feature-level association matrix.

In particular, the initial association matrix A∈ [symbol] ^{M×N}) may be represented by the following formula:

$$A = F ( {P}_{e}^{′} ⊗ {E}_{m}^{′} )$$

where, Pₑ′ represents the first feature obtained by inputting the updated lane element Pₑ into the MLP, and Eₘ′ represents the second feature obtained by inputting the prior encoding feature Eₘ into the MLP. (Pₑ′⊗Eₘ′) represents the feature-level association matrix obtained by inputting the first feature Pₑ′ and the second feature Eₘ′ into the outer product network for outer product calculation, A represents inputting the feature-level association matrix (Pₑ′⊗Eₘ′) into the classification network to generate the initial association matrix, and M and N respectively represent the number of the updated lane elements and the number of the historical lane elements. F represents a classification operation, and ⊗ represents a vector outer product.

In this implementation, by inputting the updated lane element and the prior encoding feature respectively into the multilayer perceptron network to generate the first feature and the second feature, inputting the first feature and the second feature into the outer product network to generate the feature-level association matrix, and inputting the feature-level association matrix into the classification network to generate the initial association matrix, the reliability and accuracy of the determined initial association matrix is improved.

In some alternative implementations, inputting the initial association matrix into a second association network to generate a target association matrix, includes: inputting the initial association matrix into a matching network to generate a matched association matrix; and inputting the matched association matrix into a filtering network to generate the target association matrix.

In this implementation, the second association network may include the matching network and the filtering network. The executing body may first input the initial association matrix into the matching network to generate the matched association matrix, and then input the matched association matrix into the filtering network to generate the target association matrix.

The matching network may match the initial association matrix using a preset matching strategy, which is to match each updated lane element with at most one historical lane element, and match each historical lane element with at most one target lane element.

Here, the preset matching strategy may include the Hungarian matching strategy, i.e., the Hungarian matching algorithm, which is an algorithm used to solve the maximum matching problem in bipartite graphs, and is commonly used to deal with problems such as task allocation, or resource allocation.

The filtering network may be used to filter an element in the matched association matrix based on a confidence of the updated lane element and/or a matching degree between the updated lane element and the target lane element (e.g., an element, in the matched association matrix, corresponding to the updated lane element having a confidence lower than a preset confidence threshold and/or an updated lane element with a matching degree between the updated lane element and the target lane element lower than a preset matching degree threshold is filtered out).

In this implementation, by inputting the initial association matrix into the matching network to generate the matched association matrix, and inputting the matched association matrix into the filtering network to generate the target association matrix, the reliability of the generated target association matrix is improved.

In some alternative implementations, the first sub-loss function may include a regression loss function, a cosine similarity loss function and a classification loss function.

In this implementation, the executing body may determine the first sub-loss function based on the regression loss function, the cosine similarity loss function, and the classification loss function, as well as weights corresponding to the loss functions.

The regression loss function is mainly used for regression tasks in supervised learning, with the purpose of predicting continuous-valued outputs; the cosine similarity loss function is commonly used to evaluate whether directions of two vectors are close; and the classification loss function is commonly used for classification problems in supervised learning.

For the first sub-loss function, the regression loss function may be used to determine whether the coordinates of the updated lane element are close to that of the target lane element. The cosine similarity loss function is used to determine whether the direction of the vector of the updated lane element is close to that of the target lane element. The classification loss function is used to determine whether the class of the updated lane element is close to that of the target lane element.

Here, a third weight corresponding to the regression loss function may be positively correlated with a preset third confidence threshold for the coordinate of the updated lane element, a fourth weight corresponding to the cosine similarity loss function may be positively correlated with a preset fourth confidence threshold for the coordinate of the updated lane element, and a fifth weight corresponding to the classification loss function may be positively correlated with a preset fifth confidence threshold for the class of the updated lane element.

In this implementation, by setting the loss function to include the regression loss function, the cosine similarity loss function, and the classification loss function, the accuracy of the determined first sub-loss function is improved.

In some alternative implementations, the second sub-loss function is a classification loss function constructed based on the change type of the updated lane element and the change type of the target lane element.

In this implementation, the change type of the updated lane element may be represented through the target association matrix, where an element in the target association matrix may represent the change type of an updated lane element relative to a historical lane element. The classification loss function is constructed based on the target association matrix and the change type of the target lane element, i.e., the change between the updated lane element and the historical lane element is regarded as a classification task.

In particular, the second sub-loss function L_{c} may be represented by the following formula:

$${L}_{c} = {\sum }_{i = 1}^{M} {\sum }_{j = 1}^{N} {L}_{f} ( {M}_{ij} , {\hat{y}}_{ij} )$$

where, Mᵢⱼ represents an element in the target association matrix, i.e., a matrix element, ŷᵢⱼ represents a truth label corresponding to Mᵢⱼ, i.e., the change type of the target lane element, and L_{f} represents the loss function used for classification.

In this implementation, by setting the second sub-loss function as the classification loss function constructed based on the change type of the updated lane element and the change type of the target lane element, the reliability of the determined second sub-loss function is improved.

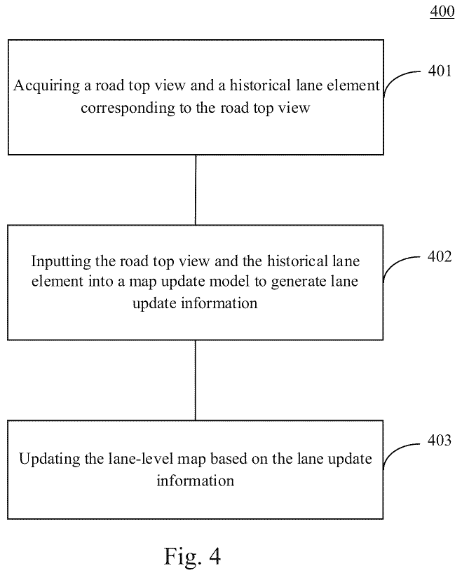

FIG. 4 shows a flow 400 of an embodiment of a method for updating a lane-level map. The method for updating a lane-level map may, in particular, include the following steps.

Step 401, acquiring a road top view and a historical lane element corresponding to the road top view.

In the present embodiment, the executing body may first acquire the road top view locally or at a remote server where the road top view is stored.

Further, the executing body may map a region corresponding to the road top view to a lane-level map, to obtain a mapping region, and determine a lane element in the mapping region as the historical lane element corresponding to the road top view.

Step 402, inputting the road top view and the historical lane element into a map update model to generate lane update information.

In the present embodiment, the executing body may input the road top view and the historical lane element into the map update model to generate the lane update information.

The map update model may be a map update model obtained by using the method described in the corresponding embodiments of FIG. 2 and FIG. 3, and detailed description thereof will be omitted.

Step 403, updating the lane-level map based on the lane update information.

In the present embodiment, if the lane update information includes an updated lane element, the executing body may update the lane-level map based on the updated lane element; if the lane update information includes an updated lane element and a change type of the updated lane element, the executing body may update the lane-level map based on the updated lane element and the change type of the updated lane element to obtain the updated lane-level map.

Here, it should be noted that for the updated lane-level map, the change type of the updated lane element may be displayed on the updated lane-level map either in the form of characters or in the form of colours of the updated lane element (e.g., element style change is indicated by blue, no change in element style by purple, element addition by red, and element deletion by orange), which is not limited herein.

The above embodiment of the present disclosure provides the method for updating a lane-level map, by acquiring the road top view and the historical lane element corresponding to the road top view, inputting the road top view and the historical lane element into the map update model to generate the lane update information, and updating the lane-level map based on the lane update information, the efficiency of generating the lane-level map as well as the accuracy and reliability of the generated lane-level map are improved.

In some alternative implementations, the method further includes: performing at least one of the following based on the updated lane-level map; determining road lane-level traffic information; determining a lane-level candidate planning trajectory; and determining a lane-level control strategy for a vehicle.

In this implementation, the executing body may determine the road lane-level traffic information based on the updated lane-level map.

Here, the road lane-level traffic information may include lane usage frequency, traffic density, lane usage, etc. The road lane-level traffic information may help optimize lane allocation, traffic signal control to alleviate problems such as traffic congestion.

Further, the executing body may determine the lane-level candidate planning trajectory based on the updated lane-level map, in order to avoid lanes with high-frequency lane changes or frequent accidents, thereby enhancing the reliability and safety of autonomous driving.

Further, the executing body may perform high-precision driving behavior modeling based on the updated lane-level map to determine the lane-level control strategy, so that an autonomous driving system can better learn behavior patterns (e.g., lane changing, overtaking and avoidance) of human drivers.

On the basis of the embodiment corresponding to FIG. 4, the finally obtained updated lane-level map may also be applied to a route navigation scenario to implement lane-level navigation.

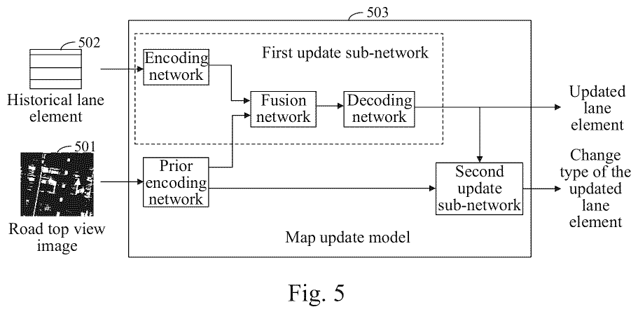

With further reference to FIG. 5, FIG. 5 is a schematic diagram of an application scenario of the method for updating a lane-level map according to the present embodiment.

The executing body may acquire a road top view image 501 via an image collection device of an autonomous driving vehicle, map a region corresponding to the road top view image 501 to a lane-level map to obtain a mapping region, and determine a lane element in the mapping region as a historical lane element 502 corresponding to the road top view image. Further, the executing body may input the road top view image 501 and the historical lane element 502 corresponding to the road top view image into a map update model 503 to generate lane update information. Here, the map update model 503 may include a prior encoding network and an update network. The update network may include a first update sub-network and a second update sub-network. The first update sub-network may include an encoding network, a fusion network and a decoding network, where the prior encoding network is used to encode the historical lane element to generate a prior encoding feature, the encoding network is used to encode the road top view to generate an image feature, the fusion network is used to fuse the image feature with the prior encoding feature to generate a fusion feature, and the decoding network is used to decode the fusion feature to generate an updated lane element. The second update sub-network is used to generate a change type of the updated lane element based on the updated lane element and the prior encoding feature.

Further, the executing body may update the lane-level map based on the updated lane element and the change type of the updated lane element to obtain the updated lane-level map.

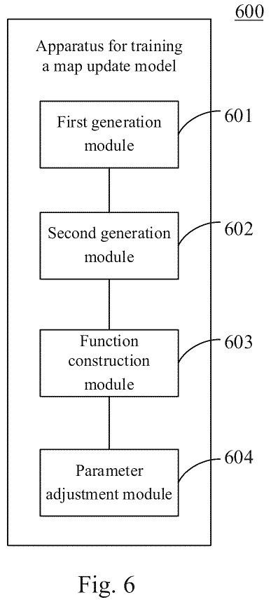

With further reference to FIG. 6, as an implementation of the method shown in the above figures, the present disclosure provides an embodiment of an apparatus for training a map update model. The apparatus embodiment corresponds to the method embodiment shown in FIG. 2.

As shown in FIG. 6, the apparatus 600 for training a map update model in the present embodiment includes: a first generation module 601, a second generation module 602, a function construction module 603 and a parameter adjustment module 604.

The first generation module 601 may be configured to input a historical lane element corresponding to a road top view sample into the prior encoding network to generate a prior encoding feature.

The second generation module 602 may be configured to input the prior encoding feature and the road top view sample into the update network to generate lane update information.

The function construction module 603 may be configured to construct a loss function based on the lane update information and a target lane element corresponding to the road top view sample.

The parameter adjusting module 604 may be configured to adjust a parameter of the map update model based on the loss function.

In some optional implementations of the present embodiment, the function construction module is further configured to: construct a first sub-loss function based on the updated lane element and the target lane element; construct a second sub-loss function, based on the change type of the updated lane element and a change type of the target lane element; and determine the loss function based on the first sub-loss function and the second sub-loss function.

In some optional implementations of the present embodiment, the change type includes at least one of: element style change, no change in element style, element addition, or element deletion.

In some optional implementations of the present embodiment, the update network includes a first update sub-network and a second update sub-network, and the second generation module further includes: a first update unit, configured to input the prior encoding feature and the road top view sample into the first update sub-network to generate the updated lane element; and a second updating unit, configured to input the updated lane element and the prior encoding feature into the second update sub-network to generate the change type of the updated lane element.

In some optional implementations of the present embodiment, the second updating unit is further configured to: input the updated lane element and the prior encoding feature into the first association network to generate an initial association matrix; and input the initial association matrix into the second association network to generate a target association matrix.

In some optional implementations of the present embodiment, inputting the updated lane element and the prior encoding feature into the first association network to generate an initial association matrix, includes: inputting the updated lane element and the prior encoding feature respectively into the multilayer perceptron network to generate a first feature and a second feature; inputting the first feature and the second feature into the outer product network to generate a feature-level association matrix; and inputting the feature-level association matrix into the classification network to generate the initial association matrix.

In some optional implementations of the present embodiment, inputting the initial association matrix into the second association network to generate a target association matrix, includes: inputting the initial association matrix into the matching network to generate a matched association matrix; and inputting the matched association matrix into the filtering network to generate the target association matrix.

In some optional implementations of the present embodiment, the first sub-loss function includes: a regression loss function, a cosine similarity loss function and a classification loss function.

In some optional implementations of the present embodiment, the second sub-loss function is a classification loss function constructed based on the change type of the updated lane element and the change type of the target lane element.

In some optional implementations of the present embodiment, both the historical lane element and the target lane element include an element vectorization point set and element style information.

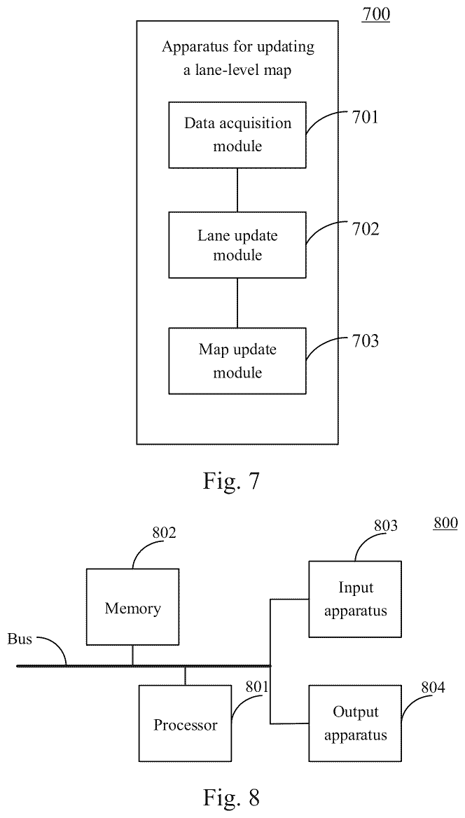

With further reference to FIG. 7, as an implementation of the method shown in the above figures, the present disclosure provides an embodiment of an apparatus for updating a lane-level map. The apparatus embodiment corresponds to the method embodiment shown in FIG. 4.

As shown in FIG. 7, the apparatus 700 for updating a lane-level map in the present embodiment includes: a data acquisition module 701, a lane update module 702, and a map update module 703.

The data acquisition module 701 may be configured to acquire a road top view and a historical lane element corresponding to the road top view.

The lane update module 702 may be configured to input the road top view and the historical lane element into a map update model to generate lane update information.

The map update module 703 may be configured to update the lane-level map based on the lane update information.

In some optional implementations of the present embodiment, the apparatus further includes a strategy performing module, and the strategy performing module is configured to perform at least one of the following items based on the updated lane-level map: determining road lane-level traffic information; determining a lane-level candidate planning trajectory; and determining a lane-level control strategy for a vehicle.

The present disclosure further provides an apparatus for navigating, the apparatus includes a map navigation module, and the map navigation module is configured to perform route navigation based on a target lane-level map. The target lane-level map is the updated lane-level map obtained by using the apparatus for updating a lane-level map shown in FIG. 7.

In the technical solution of the present disclosure, the acquisition, storage, application, etc. of the personal information of a user all comply with the provisions of the relevant laws and regulations, and do not violate public order and good customs.

According to embodiments of the present disclosure, the present disclosure further provides an electronic device, a readable storage medium, and a computer program product.

As shown in FIG. 8, is a block diagram of an electronic device for the method of training a map update model according to an embodiment of the present disclosure.

800 is a block diagram of an electronic device of a method for training a map update model according to an embodiment of the present disclosure. The electronic device is intended to represent various forms of digital computers, such as laptop computers, desktop computers, workbenches, personal digital assistants, servers, blade servers, mainframe computers, and other suitable computers. The electronic device may also represent various forms of mobile apparatuses, such as personal digital processing, cellular phones, smart phones, wearable devices, and other similar computing apparatuses. The components shown herein, their connections and relationships, and their functions are merely examples, and are not intended to limit the implementation of the present disclosure described and/or claimed herein.

As shown in FIG. 8, the electronic device includes: one or more processors 801, a memory 802, and interfaces for connecting various components, including high-speed interfaces and low-speed interfaces. The various components are connected to each other using different buses, and may be installed on a common motherboard or in other methods as needed. The processor may process instructions executed within the electronic device, including instructions stored in or on the memory to display graphic information of GUI on an external input/output apparatus (such as a display device coupled to the interface). In other embodiments, a plurality of processors and/or a plurality of buses may be used together with a plurality of memories if desired. Similarly, a plurality of electronic devices may be connected, and the devices provide some necessary operations (for example, as a server array, a set of blade servers, or a multi-processor system). In FIG. 8, one processor 801 is used as an example.

The memory 802 is a non-transitory computer readable storage medium provided by the present disclosure. The memory stores instructions executable by at least one processor, so that the at least one processor performs the method for training a map update model provided by the present disclosure. The non-transitory computer readable storage medium of the present disclosure stores computer instructions for causing a computer to perform the method for training a map update model provided by the present disclosure.

The memory 802 serves as a non-transitory computer readable storage medium that can be used to store non-transitory software programs, non-transitory computer executable programs, and modules, such as program instructions/modules corresponding to the method for training a map update model in embodiments of the present disclosure (e.g., the first generation module 601, the second generation module 602, the function construction module 603, and the parameter adjustment module 604 shown in FIG. 6). The processor 801 executes various functional applications and data processing in the server by running the non-transitory software programs, instructions, and modules stored in the memory 802, i.e., implementing the method for training a map update model in the above method embodiments.

The memory 802 may include a storage program area and a storage data area, where the storage program area may store an operating system and at least one function required application program; and the storage data area may store data created by the use of the electronic device according to the method for processing parking, etc. In addition, the memory 802 may include a high-speed random access memory, and may also include a non-transitory memory, such as at least one magnetic disk storage device, a flash memory device, or other non-transitory solid-state storage devices. In some embodiments, the memory 802 may optionally include memories remotely provided with respect to the processor 801, and these remote memories may be connected to the electronic device of the method for processing parking through a network. Examples of the above network include but are not limited to the Internet, intranet, local area network, mobile communication network, and combinations thereof.

The electronic device of the method for training a map update model may further include: an input apparatus 803 and an output apparatus 804. The processor 801, the memory 802, the input apparatus 803, and the output apparatus 804 may be connected through a bus or in other methods. In FIG. 8, connection through a bus is used as an example.

The input apparatus 803 may receive input digital or character information, and generate key signal inputs related to user settings and function control of the electronic device of the method for processing parking, such as touch screen, keypad, mouse, trackpad, touchpad, pointing stick, one or more mouse buttons, trackball, joystick and other input apparatuses. The output apparatus 804 may include a display device, an auxiliary lighting apparatus (for example, LED), a tactile feedback apparatus (for example, a vibration motor), and the like. The display device may include, but is not limited to, a liquid crystal display (LCD), a light emitting diode (LED) display, and a plasma display. In some embodiments, the display device may be a touch screen.

Various embodiments of the systems and technologies described herein may be implemented in digital electronic circuit systems, integrated circuit systems, dedicated ASICs (application specific integrated circuits), computer hardware, firmware, software, and/or combinations thereof. These various embodiments may include: being implemented in one or more computer programs that can be executed and/or interpreted on a programmable system that includes at least one programmable processor. The programmable processor may be a dedicated or general-purpose programmable processor, and may receive data and instructions from a storage system, at least one input apparatus, and at least one output apparatus, and transmit the data and instructions to the storage system, the at least one input apparatus, and the at least one output apparatus.

These computing programs (also referred to as programs, software, software applications, or codes) include machine instructions of the programmable processor and may use high-level processes and/or object-oriented programming languages, and/or assembly/machine languages to implement these computing programs. As used herein, the terms “machine readable medium” and “computer readable medium” refer to any computer program product, device, and/or apparatus (for example, magnetic disk, optical disk, memory, programmable logic apparatus (PLD)) used to provide machine instructions and/or data to the programmable processor, including machine readable medium that receives machine instructions as machine readable signals. The term “machine readable signal” refers to any signal used to provide machine instructions and/or data to the programmable processor.

In order to provide interaction with a user, the systems and technologies described herein may be implemented on a computer, the computer has: a display apparatus for displaying information to the user (for example, CRT (cathode ray tube) or LCD (liquid crystal display) monitor); and a keyboard and a pointing apparatus (for example, mouse or trackball), and the user may use the keyboard and the pointing apparatus to provide input to the computer. Other types of apparatuses may also be used to provide interaction with the user; for example, feedback provided to the user may be any form of sensory feedback (for example, visual feedback, auditory feedback, or tactile feedback); and any form (including acoustic input, voice input, or tactile input) may be used to receive input from the user.

The systems and technologies described herein may be implemented in a computing system that includes backend components (e.g., as a data server), or a computing system that includes middleware components (e.g., application server), or a computing system that includes frontend components (for example, a user computer having a graphical user interface or a web browser, through which the user may interact with the implementations of the systems and the technologies described herein), or a computing system that includes any combination of such backend components, middleware components, or frontend components. The components of the system may be interconnected by any form or medium of digital data communication (e.g., communication network). Examples of the communication network include: local area networks (LAN), wide area networks (WAN), the Internet, and blockchain networks.

The computer system may include a client and a server. The client and the server are generally far from each other and usually interact through the communication network. The relationship between the client and the server is generated by computer programs that run on the corresponding computer and have a client-server relationship with each other.

According to the technical solution of the embodiments of the present disclosure, the accuracy and reliability of the map update model obtained by training is improved.

It should be understood that the various forms of processes shown above may be used to reorder, add, or delete steps. For example, the steps described in the present disclosure may be performed in parallel, sequentially, or in different orders. As long as the desired results of the technical solution disclosed in the present disclosure can be achieved, no limitation is made herein.

The above specific embodiments do not constitute limitation on the protection scope of the present disclosure. Those skilled in the art should understand that various modifications, combinations, sub-combinations and substitutions may be made according to design requirements and other factors. Any modification, equivalent replacement and improvement made within the spirit and principle of the present disclosure shall be included in the protection scope of the present disclosure.

What is claimed is:

1. A method for training a map update model, the map update model comprising a prior encoding network and an update network, and the method comprising:
inputting a historical lane element corresponding to a road top view sample into the prior encoding network to generate a prior encoding feature, the prior encoding network being used to encode geometric features, semantic features and spatial relationship features of lane elements;
inputting the prior encoding feature and the road top view sample into the update network to generate lane update information;
constructing a loss function based on the lane update information and a target lane element corresponding to the road top view sample; and
adjusting a parameter of the map update model based on the loss function.

2. The method according to claim 1, wherein the lane update information comprises an updated lane element and a change type of the updated lane element, and constructing the loss function based on the lane update information and the target lane element corresponding to the road top view sample, comprises:
constructing a first sub-loss function, based on the updated lane element and the target lane element;
constructing a second sub-loss function, based on the change type of the updated lane element and a change type of the target lane element; and
determining the loss function, based on the first sub-loss function and the second sub-loss function.

3. The method according to claim 2, wherein the change type comprises at least one of: element style change, no change in element style, element addition, or element deletion; and/or
wherein the update network comprises a first update sub-network and a second update sub-network, and inputting the prior encoding feature and the road top view sample into the update network to generate the lane update information, comprises:
inputting the prior encoding feature and the road top view sample into the first update sub-network to generate the updated lane element; and
inputting the updated lane element and the prior encoding feature into the second update sub-network to generate the change type of the updated lane element.

4. The method according to claim 3, wherein the second update sub-network comprises a first association network and a second association network, and inputting the updated lane element and the prior encoding feature into the second update sub-network to generate the change type of the updated lane element, comprises:
inputting the updated lane element and the prior encoding feature into the first association network to generate an initial association matrix; and
inputting the initial association matrix into the second association network to generate a target association matrix, wherein one element in the target association matrix is used to indicate a change type of one lane element.

5. The method according to claim 4, wherein the first association network comprises: a multilayer perceptron network, an outer product network and a classification network, and inputting the updated lane element and the prior encoding feature into the first association network to generate the initial association matrix, comprises:
inputting the updated lane element and the prior encoding feature respectively into the multilayer perceptron network to generate a first feature and a second feature;
inputting the first feature and the second feature into the outer product network to generate a feature-level association matrix; and
inputting the feature-level association matrix into the classification network to generate the initial association matrix.

6. The method according to claim 4, wherein the second association network comprises a matching network and a filtering network, and the inputting the initial association matrix into the second association network to generate a target association matrix, comprises:
inputting the initial association matrix into the matching network to generate a matched association matrix, the matching network being used to match the initial association matrix using a preset matching strategy; and
inputting the matched association matrix into the filtering network to generate the target association matrix, the filtering network being used to filter an element in the matched association matrix based on a confidence of the updated lane element and/or a matching degree between the updated lane element and the target lane element.

7. The method according to claim 2, wherein the first sub-loss function comprises: a regression loss function, a cosine similarity loss function and a classification loss function; and/or
wherein the second sub-loss function is a classification loss function constructed based on the change type of the updated lane element and the change type of the target lane element.

8. The method according to claim 1, wherein both the historical lane element and the target lane element comprise an element vectorization point set and element style information.

9. A method for updating a lane-level map, the method comprising:
acquiring a road top view and a historical lane element corresponding to the road top view;
inputting the road top view and the historical lane element into a map update model to generate lane update information, wherein the map update model is a map update model obtained by:
inputting a historical lane element corresponding to a road top view sample into the prior encoding network to generate a prior encoding feature, the prior encoding network being used to encode geometric features, semantic features and spatial relationship features of lane elements;
inputting the prior encoding feature and the road top view sample into an update network to generate lane update information;
constructing a loss function based on the lane update information and a target lane element corresponding to the road top view sample; and
adjusting a parameter of the map update model based on the loss function; and
updating the lane-level map based on the lane update information.

10. The method according to claim 9, wherein the method further comprises:
performing at least one of following items based on the updated lane-level map:
determining road lane-level traffic information;
determining a lane-level candidate planning trajectory; and
determining a lane-level control strategy for a vehicle.

11. The method according to claim 9, wherein the method further comprises:
performing route navigation based on the updated lane-level map.

12. An electronic device, comprising:
at least one processor; and
a memory, communicatively connected to the at least one processor;
wherein the memory stores instructions executable by the at least one processor, and the instructions are executed by the at least one processor, to enable the at least one processor to perform operations, the operations comprising:
inputting a historical lane element corresponding to a road top view sample into a prior encoding network to generate a prior encoding feature, the prior encoding network being used to encode geometric features, semantic features and spatial relationship features of lane elements;
inputting the prior encoding feature and the road top view sample into the update network to generate lane update information;
constructing a loss function based on the lane update information and a target lane element corresponding to the road top view sample; and
adjusting a parameter of a map update model based on the loss function.

13. The electronic device according to claim 12, wherein the lane update information comprises an updated lane element and a change type of the updated lane element, and constructing the loss function based on the lane update information and the target lane element corresponding to the road top view sample, comprises:
constructing a first sub-loss function, based on the updated lane element and the target lane element;
constructing a second sub-loss function, based on the change type of the updated lane element and a change type of the target lane element; and
determining the loss function, based on the first sub-loss function and the second sub-loss function.

14. The electronic device according to claim 13, wherein the change type comprises at least one of: element style change, no change in element style, element addition, or element deletion; and/or
the update network comprises a first update sub-network and a second update sub-network, and inputting the prior encoding feature and the road top view sample into the update network to generate the lane update information, comprises:
inputting the prior encoding feature and the road top view sample into the first update sub-network to generate the updated lane element; and
inputting the updated lane element and the prior encoding feature into the second update sub-network to generate the change type of the updated lane element.

15. The electronic device according to claim 14, wherein the second update sub-network comprises a first association network and a second association network, and inputting the updated lane element and the prior encoding feature into the second update sub-network to generate the change type of the updated lane element, comprises:
inputting the updated lane element and the prior encoding feature into the first association network to generate an initial association matrix; and
inputting the initial association matrix into the second association network to generate a target association matrix, wherein one element in the target association matrix is used to indicate a change type of one lane element.

16. The electronic device according to claim 15, wherein the first association network comprises: a multilayer perceptron network, an outer product network and a classification network, and inputting the updated lane element and the prior encoding feature into the first association network to generate the initial association matrix, comprises:
inputting the updated lane element and the prior encoding feature respectively into the multilayer perceptron network to generate a first feature and a second feature;
inputting the first feature and the second feature into the outer product network to generate a feature-level association matrix; and
inputting the feature-level association matrix into the classification network to generate the initial association matrix.

17. The electronic device according to claim 15, wherein the second association network comprises a matching network and a filtering network, and the inputting the initial association matrix into the second association network to generate a target association matrix, comprises:
inputting the initial association matrix into the matching network to generate a matched association matrix, the matching network being used to match the initial association matrix using a preset matching strategy; and
inputting the matched association matrix into the filtering network to generate the target association matrix, the filtering network being used to filter an element in the matched association matrix based on a confidence of the updated lane element and/or a matching degree between the updated lane element and the target lane element.

18. The electronic device according to claim 13, wherein the first sub-loss function comprises: a regression loss function, a cosine similarity loss function and a classification loss function; and/or
wherein the second sub-loss function is a classification loss function constructed based on the change type of the updated lane element and the change type of the target lane element.

19. An electronic device, comprising:
at least one processor; and
a memory, communicatively connected to the at least one processor;
wherein the memory stores instructions executable by the at least one processor, and the instructions are executed by the at least one processor, to enable the at least one processor to perform the method according to claim 9.

20. A non-transitory computer readable storage medium, storing a computer instruction, wherein the computer instruction is used to cause a computer to perform the method according to claim 1.
